(19) United States
(12) Patent Application Publication
(10) Pub. No.: US 2023/0097086 A1
(43) Pub. Date: Mar. 30, 2023

(54) COMPRESSION COUPLING FOR DRAIN CLEANING CABLE

(71) Applicant: Emerson Professional Tools, LLC., Elyria, OH (US)

(72) Inventors: Jeffrey SZUCS, Columbia Station, OH (US); Alex Michael COLE, Columbia Station, OH (US)

(21) Appl. No.: 17/953,494

(22) Filed: Sep. 27, 2022

Related U.S. Application Data
(60) Provisional application No. 63/249,071, filed on Sep. 28, 2021.

(51) Int. Cl. B08B 9/045; F16C 1/06; F16C 1/08

(52) U.S. Cl. CPC B08B 9/045; F16C 1/06; F16C 1/08; B08B 2209/04

(57) ABSTRACT

A cable coupling for use with rotating cables is described. The cable coupling comprises a ferrule, a compression die, an adapter die, and a threaded nut cap. In particular versions, the cable coupling is used with high speed drain cleaning cables.

### CROSS REFERENCES TO RELATED APPLICATIONS

This application claims priority from U.S. provisional application Ser. No. 63/249,071 filed on Sep. 28, 2021.

### FIELD

The present subject matter relates to assemblies for engagement of a cable to a rotary power source. In particular versions, the subject matter also relates to assemblies for engagement of a sheathed drain cleaning cable to a rotary power source.

### BACKGROUND

Certain high speed drain cleaning equipment utilizes a cable that is typically lubricated and rotatably held within a sheath. The cable rotates a tool that is inserted into a drain line or other members to clean or dislodge debris within the drain line. In order to attach the cable assembly to a rotary drive mechanism, the cable requires the addition of a cable coupling. Known cable couplings for high speed drain cleaning are typically of two constructions. In a first construction, a cable is inserted into a fitting and fastened to a rotatable drive member by a plurality of set screws. In a second construction, a cable is inserted into a fitting which is permanently crimped to a rotatable drive member.

Each cable coupling has associated benefits and disadvantages.

The first construction enables a user to service the assembly in the field. The user may remove and replace the coupling with simple tools and allows for cable repair and replacement. This construction, however, requires the user to torque the set screws to an appropriate torque range or else the cable may be weakened by resulting stresses or the cable may slip in the coupling during operation.

The second construction is not a field serviceable design, as the coupling utilizes a permanent irreversible crimp. The coupling requires a particular configuration according to the amount of crimp force necessary to achieve engagement between the crimped coupling and cable so as to not sacrifice cable strength or allow for cable slip. Additionally, this second construction requires that the coupling is attached to a cable with the use of a crimping tool. A user may not have access to such a specialized tool.

Although such known cable couplings are satisfactory in many respects, a need exists for an improved cable coupling.

### SUMMARY

The difficulties and drawbacks associated with previous approaches are addressed in the present subject matter as follows.

In a first aspect, the present subject matter provides a cable coupling comprising a ferrule having a proximal end and a distal end, and defining an interior aperture extending between the proximal end and the distal end of the ferrule. The ferrule further has at least one inclined surface along an outer region of the ferrule. The cable coupling also comprises a compression die having a proximal end and a distal end, and defining an interior aperture extending between the proximal end and the distal end of the compression die. The compression die further has a threaded region accessible along an outer surface of the compression die. The cable coupling also comprises an adapter die having a proximal end and a distal end, and defining an interior receiving region accessible from the distal end of the adapter die. The adapter die further has an enlarged head. The cable coupling also comprises a threaded nut cap defining a proximal end and a distal end, and defining an interior aperture extending between the proximal end and the distal end of the nut cap. The nut cap further has a threaded region accessible along the interior aperture of the nut cap. The nut cap further has a capture region sized and shaped to engage and contact the enlarged head of the adapter die upon assembly of the cable coupling.

In another aspect, the present subject matter provides an assembly comprising a cable defining a proximal end, and a ferrule having a proximal end and a distal end, and defining an interior aperture extending between the proximal end and the distal end of the ferrule. The ferrule further has at least one inclined surface along an outer region of the ferrule. The cable is disposed in the interior aperture of the ferrule. The assembly further comprises a compression die having a proximal end and a distal end, and defining an interior aperture extending between the proximal end and the distal end of the compression die. The cable is disposed in the interior aperture of the compression die. The compression die further has a threaded region accessible along an outer surface of the compression die. The assembly also comprises an adapter die having a proximal end and a distal end, and defining an interior receiving region accessible from the distal end of the adapter die. The proximal end of the cable is disposed in the interior receiving region of the adapter die. The adapter die further has an enlarged head. The assembly also comprises a threaded nut cap defining a proximal end and a distal end, and defining an interior aperture extending between the proximal end and the distal end of the nut cap. The nut cap further has a threaded region accessible along the interior aperture of the nut cap. The nut cap further has a capture region sized and shaped to engage and contact the enlarged head of the adapter die upon assembly of the cable coupling.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a perspective view of an embodiment of a cable coupling engaged to a sheathed high speed drain cleaning cable in accordance with the present subject matter.

FIG. 2 is an elevational view of the cable coupling and sheathed high speed drain cleaning cable depicted in FIG. 1.

FIG. 3 is a schematic cross sectional view of the cable coupling and sheathed high speed drain cleaning cable of FIG. 1.

FIG. 4 is an exploded assembly view of the cable coupling and sheathed high speed drain cleaning cable of FIG. 1.

FIG. 5 is a partial sectional view of the components depicted in FIG. 4.

FIG. 5A is a detailed view illustrating engagement between a sheathed cable and a motor by use of the cable coupling.

FIG. 6 is a perspective view of another embodiment of a cable coupling engaged to a sheathed high speed drain cleaning cable in accordance with the present subject matter.

FIG. 7 is an elevational view of the cable coupling and sheathed high speed drain cleaning cable depicted in FIG. 6.

FIG. 8 is a schematic cross sectional view of the cable coupling and sheathed high speed drain cleaning cable of FIG. 6.

FIG. 9 is an exploded assembly view of the cable coupling and sheathed high speed drain cleaning cable of FIG. 6.

FIG. 10 is a partial sectional view of the components depicted in FIG. 9.

FIG. 11 is a perspective view of another embodiment of a cable coupling engaged to a sheathed high speed drain cleaning cable in accordance with the present subject matter.

FIG. 12 is a perspective view of a ferrule utilized in the cable coupling depicted in FIG. 11.

FIG. 13 is an elevational view of the cable coupling and sheathed high speed drain cleaning cable depicted in FIG. 11.

FIG. 14 is a schematic cross sectional view of the cable coupling and sheathed high speed drain cleaning cable of FIG. 11.

FIG. 15 is an exploded assembly view of the cable coupling and sheathed high speed drain cleaning cable of FIG. 11.

FIG. 16 is a partial sectional view of the components depicted in FIG. 15.

### DETAILED DESCRIPTION OF THE EMBODIMENTS

The present subject matter is directed to cable couplings that exhibit field serviceability such as the previously described first constructions combined with the efficacy of the second construction's compression fitting configuration. The present subject matter cable couplings do not require the use of a crimping tool for engagement to a cable and instead can be affixed to a cable by a user using readily available tools.

Generally, the cable couplings of the present subject matter comprise a ferrule, a compression die, an adapter die, and a threaded nut cap. The cable couplings are typically used with a sheathed high speed drain cleaning cable. Such cables typically include a rotatable cylindrical member disposed within an outer cable sheath. Although the present subject matter is described with regard to sheathed high speed drain cleaning cables, it will be understood that the present subject matter cable couplings may be used with a wide array of axially rotating cables in addition to drain cleaning cables. Furthermore, it is contemplated that the present subject matter cable couplings can also be used with cables that are free of sheaths.

Generally, the compression die of the present subject matter cable couplings is a ring-like component that includes external threads and a tapered recess on one end. The compression die is sized and shaped to initially be positioned about the cable of interest, i.e., the cable to which the cable coupling is to be attached.

In one embodiment, the ferrule is a ring-like component that is tapered at both ends or tapered at least on one end. The ferrule may include a slit extending along an axial length of the ferrule. The slit provides access to an interior aperture or bore extending through the length of the ferrule. The ferrule may include a plurality of slits. In addition, the ferrule may be in the form of two of more components. The ferrule is sized and shaped to be positioned about the cable of interest. The ferrule fits into a recessed region of the compression die upon assembly of the cable coupling as described in greater detail herein.

The end of the cable of interest and the ferrule are inserted in the adapter die. The adapter die includes a mating recess profile corresponding to that of the cable and ferrule. The adapter die and compression die each define mating profiles in the form of teeth or similar profiles that rotatably mate the two components. The adapter die further includes a second end which defines an aperture and cross hole. These features mate with a drive system's shaft such as that of a gearbox or motor.

The threaded nut is positioned over the adapter die upon assembly of the cable coupling and engagement to the cable of interest. The threaded nut is threadedly engaged with the compression die. As these components are tightened, the adapter die is urged towards the threaded adapter die and compresses the ferrule. These parts are torqued until a certain torque value or, alternatively, until the parts “bottom out” and can not be displaced together further. As the ferrule is compressed, a compression fit is created between various components of the system and the cable. When a drive mechanism axially rotates the adapter die, the cable coupling assembly rotates and in turn, axially rotates the cable.

If the cable is damaged near the coupling, the user may loosen the threaded nut from the compression die until the components are disengaged. At this point the ferrule may be too tight to remove and may require a replacement. A section of cable and sheath can be cut off from the cable end, and the process of engaging the cable coupling to the cable repeated.

Because of the configuration of the cable coupling, if a torque is applied to either end of the coupling, i.e., a cable end or a drive end, the threaded nut will not loosen or tighten. The compression fit is constant—similar to a crimped joint.

Alternate constructions may include the ferrule as a non-round component. For example, the ferrule may exhibit a wide array of cross sectional shapes, i.e., circular, square, triangular, oval, and polygonal. The present subject matter also includes irregular shapes. These shapes are the shape of a cross section of the ferrule taken perpendicular to a length axis of the ferrule. Alternate constructions between the adapter die and compression die may use pins and pin guides as another configuration to rotatably lock the resulting assembly.

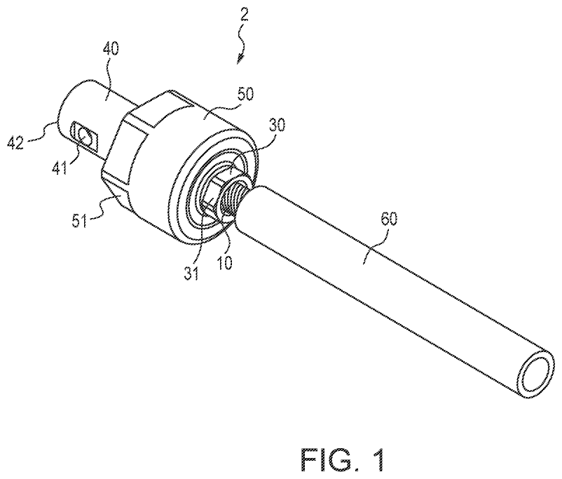

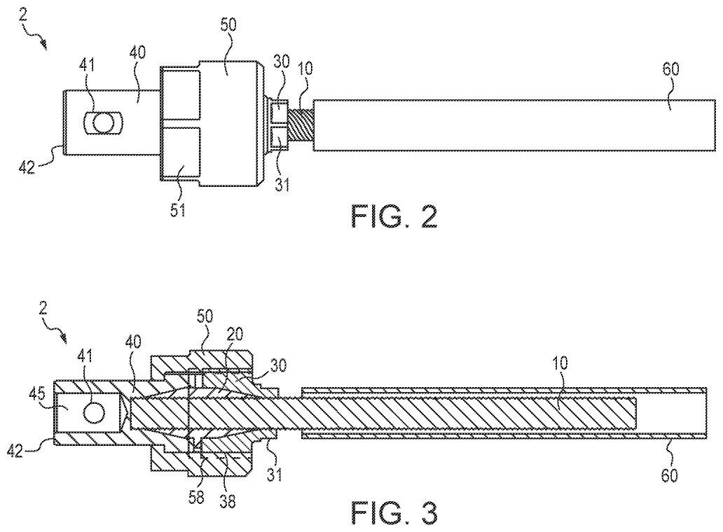

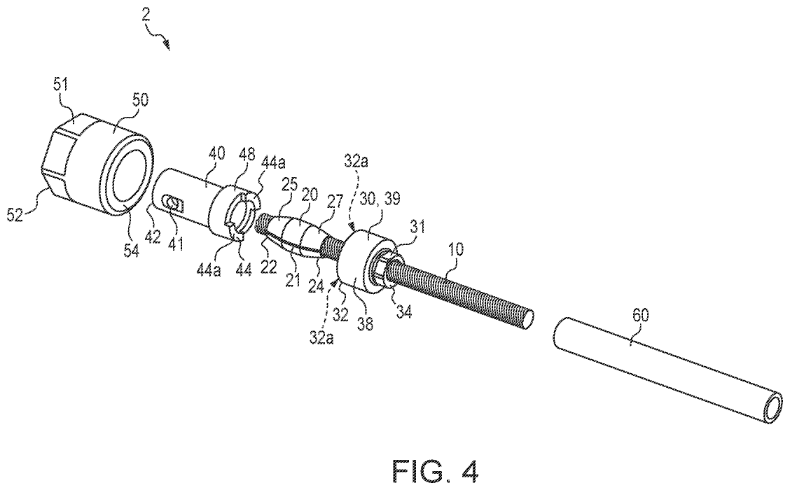

FIGS. 1-5 and 5A illustrate an embodiment of a cable coupling 2 according to the present subject matter. The cable coupling 2 comprises a ferrule 20, a threadable compression die 30, an adapter die 40, and a threaded nut cap 50. The cable coupling 2 rotatably engages a cable 10 to a rotary power source (not shown). Typically, the cable 10 is housed within an outer cable sheath 60.

The ferrule 20 defines a proximal end 22 and an opposite distal end 24. The ferrule 20 defines an interior aperture 23 extending between the ends 22, 24. In certain versions, the ferrule 20 includes a slit 21 that extends between the ends 22, 24. The slit 21 provides access to the interior aperture 23 defined in the ferrule 20 and allows for the ferrule 20 to be compressed against the cable 10. The ferrule 20 may include a plurality of slits, wherein the plurality slits may not extend fully between the ends 22, 24, or the ferrule 20 may not include any slits. Additionally, the ferrule 20 may be in the form of two or more components. The ferrule 20 also defines at least one inclined outer surface along an outer region of the ferrule 20. In the illustrated embodiment, the ferrule 20 defines a first inclined surface 25 adjacent the proximal end 22 and a second inclined surface 27 adjacent the distal end 24. However, it will be understood that the present subject matter includes the use of only one inclined surface of the ferrule 20, for example either the first inclined surface 25 of the second inclined surface 27.

The compression die 30 defines a proximal end 32 and an opposite distal end 34. The compression die 30 defines an interior aperture 33 extending between the ends 32, 34. In the event that the ferrule 20 includes a second inclined surface 27, then the compression die 30 defines a tapered interior region 37 of the interior aperture 33. The tapered interior region 37 exhibits a mating configuration corresponding to the second inclined surface 27 of the ferrule 20 such that upon assembly of the cable coupling 2 to the cable 10, at least a majority portion of the second inclined surface 27 of the ferrule 20 contacts the tapered interior region 37. The compression die 30 includes a threaded region 38 accessible along an outer surface 39 of the compression die 30. The compression die 30 typically also includes a wrench flats region 31 accessible along an exterior region of the compression die 30. In the illustrated embodiment, the wrench flats region 31 is adjacent the distal end 34 of the compression die 30. It will be understood that the present subject matter includes other arrangements.

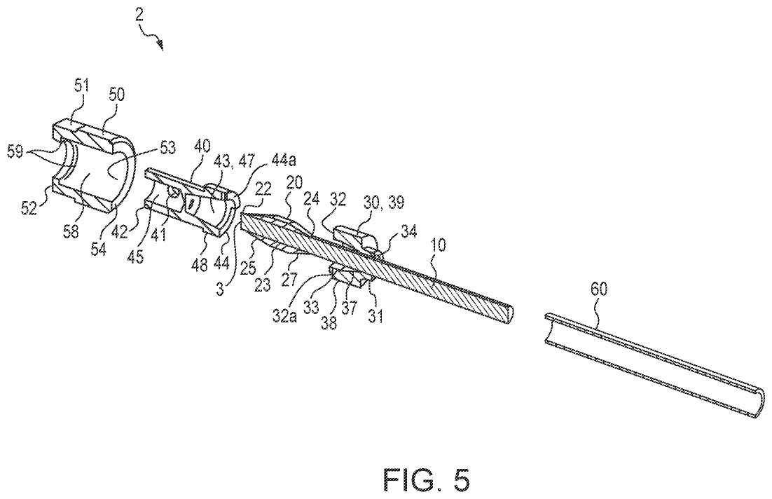

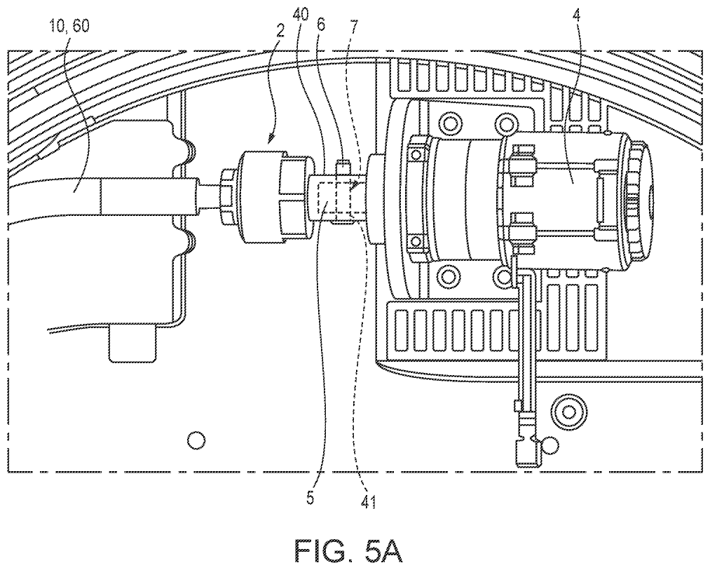

The adapter die 40 defines a proximal end 42 and an opposite distal end 44. The adapter die 40 defines an interior receiving region 43 accessible from the distal end 44. In the event that the ferrule 20 includes a first inclined surface 25, then the adapter die 40 defines a tapered interior region 47 of the receiving region 43. The tapered interior region 47 exhibits a mating configuration corresponding to the first inclined surface 25 of the ferrule 20 such that upon assembly of the cable coupling 2 to the cable 10, at least a majority portion of the first inclined surface 25 of the ferrule 20 contacts the tapered interior region 47. The adapter die 40 also includes a first shoulder region 48 extending radially outward. The adapter die 40 also defines a recess 45 and an aperture 41 (aperture 41 may be a cross hole) for engagement with a rotary drive system. As will be understood, typically the proximal end 42 of the adapter die 40 and a drive member are engaged to each other by a pin 6 or other component via the aperture 41. The drive member may be a motor 4 as shown in FIG. 5A including a shaft 5 with a second aperture 7 transverse to the axis of rotation of the motor shaft 5. In this example, the second aperture 7 is generally perpendicular to the axis of rotation. The pin 6 may be inserted through the first aperture 41 and the second aperture 7 to thereby couple the shaft 5 with adapter die 40. As the drive member or motor 4 rotates, the rotation is transferred from the drive member to the shaft 5 through the pin 6 to the adapter die 40 of the cable coupling 2. Additional examples of a drive member include a drill or other rotary power tools.

The shaft 5 is shown as cylindrical, however the shaft may be one of a plurality of shapes such as a hex or square drive and may or may not include a spring biased ball (not shown) on the exterior to engage the first aperture 41 of the adapter die 40. This alternate configuration would eliminate the need for the pin 6. Further, an alternate adapter die may include a protrusion similar to that of the shaft 5 while an alternate drive member has an engageable recess similar to that of the recess 45 of adapter die 40 with the alternate protrusion of the alternate adapter die able to be coupled the alternate drive member.

The threaded nut cap 50 defines a proximal end 52 and an opposite distal end 54. The threaded nut 50 defines an interior aperture 53 extending between the ends 52, 54. The nut cap 50 includes a threaded region 58 accessible along an interior surface of the interior aperture 53. The nut cap 50 further includes a second shoulder region 59 sized and shaped to engage and contact the first shoulder region 48 of the adapter die 40 upon assembly of the cable coupling 2. The second shoulder region 59 is typically located adjacent the proximal end 52, however, the present subject matter includes other locations for the second shoulder region 59. The threaded nut cap 50 typically also includes a wrench flats region 51 accessible along an exterior region of the nut cap 50. In the illustrated embodiment, the wrench flats region 51 is adjacent the proximal end 52 of the nut cap 50. However, it will be understood that the present subject matter includes other arrangements.

In many versions, the distal end 44 of the adapter die 40 includes one or more, and preferably a plurality of, axial extensions 44a. These axial extensions 44a are engaged in axial receiving region(s) 32a accessible at the proximal end 32 of the compression die 30. The compression die 30 includes one or more, and preferably a plurality of, axial receiving regions 32a. Upon insertion and engagement of the axial extension(s) 44a in the axial receiving region(s) 32a, loosening of the threaded nut 50 is precluded during rotation of the cable 10, in either direction.

Upon assembly of the cable coupling 2 and engagement to the cable 10, an end 3 of the cable 10 is inserted through the interior aperture 33 of the compression die 30, through the interior aperture 23 of the ferrule 20, and into the interior receiving region 43 of the adapter die 40. The ferrule 20 is disposed within the interior receiving region 43 of the adapter die 40 and within at least a portion of the interior aperture 33 of the compression die 30. The axial extension(s) 44a of the adapter die 41 are radially aligned with the axial receiving region(s) 32a of the compression die 30. The threaded nut cap 50 is positioned about the adapter die 40 and urged toward the compression die 30. The threaded region 58 of the nut cap 50 is threadedly engaged with the threaded region 38 of the compression die 30. Wrench flat regions 31 and 51 can be used to assist in rotation of the nut cap 50 relative to the compression die 30. Rotation of the nut cap 50 relative to the compression die 30 results in linear displacement of the nut cap 50 relative to the compression die 30. As previously explained, linear displacement of the nut cap 50 toward the compression die 30 causes compression of the ferrule and frictional engagement of the cable coupling 2 to the cable 10.

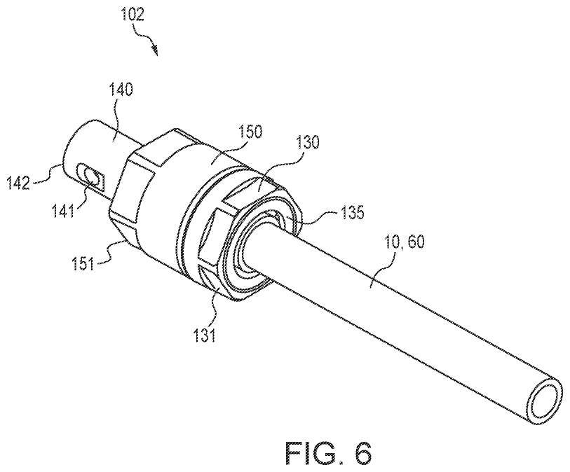

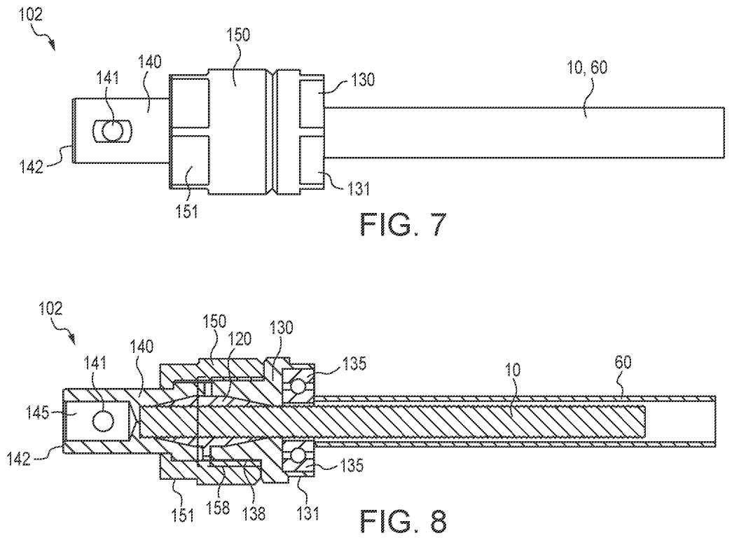

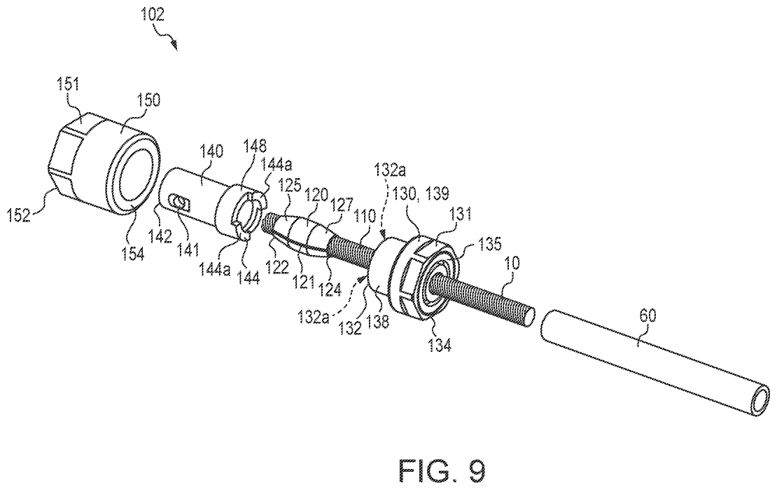

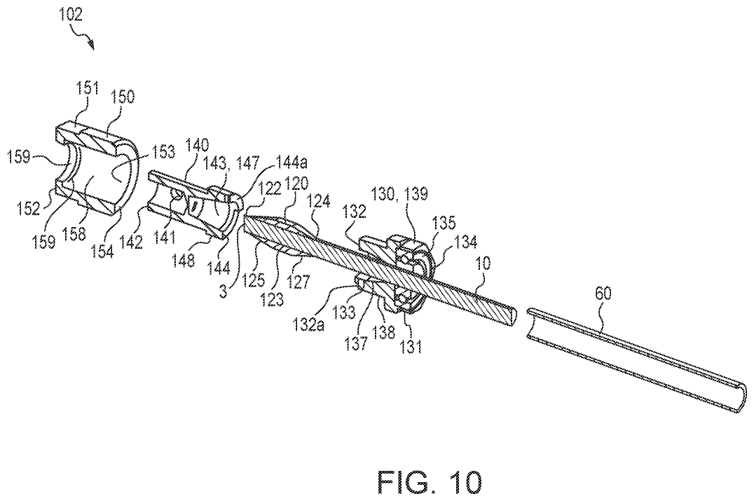

FIGS. 6-10 illustrate another embodiment of a cable coupling 102 according to the present subject matter. The cable coupling 102 comprises a ferrule 120, a threadable compression die 130, an adapter die 140, and a threaded nut cap 150. The cable coupling 102 rotatably engages a cable 10 to a drive member, such as a motor. FIG. 5A illustrates such an arrangement. Typically, the cable 10 is housed within an outer cable sheath 60.

The ferrule 120 defines a proximal end 122 and an opposite distal end 124. The ferrule 120 defines an interior aperture 123 extending between the ends 122, 124. In certain versions, the ferrule 120 includes a slit 121 that extends between the ends 122, 124. The slit 121 provides access to the interior aperture 123 defined in the ferrule 120. The ferrule 120 also defines at least one inclined surface along an outer region of the ferrule 120. In the illustrated embodiment, the ferrule 120 defines a first inclined surface 125 adjacent the proximal end 122 and a second inclined surface 127 adjacent the distal end 124. However, it will be understood that the present subject matter includes the use of only one inclined surface of the ferrule 120, for example either the first inclined surface 125 or the second inclined surface 127. The ferrule 120 can exhibit a wide array of shapes and configurations such as for example, the previously described cross-sectional shapes described for the ferrule.

The compression die 130 defines a proximal end 132 and an opposite distal end 134. The compression die 130 defines an interior aperture 133 extending between the ends 132, 134. In the event that the ferrule 120 includes a second inclined surface 127, then the compression die 130 defines a tapered interior region 137 of the interior aperture 133. The tapered interior region 137 exhibits a mating configuration corresponding to the second inclined surface 127 of the ferrule 120 such that upon assembly of the cable coupling 102 to the cable 10, at least a majority portion of the second inclined surface 127 of the ferrule 120 contacts the tapered interior region 137. The compression die 130 includes a threaded region 138 accessible along an outer surface 139 of the compression die 130. The compression die 130 typically also includes a wrench flats region 131 accessible along an exterior region of the compression die 130. The wrench flats region 131 can be adjacent the distal end 134 of the compression die 130. In the embodiment depicted in FIGS. 6-10, the compression die 130 includes a bearing assembly 135. The bearing assembly is located adjacent the distal end 134 of the compression die 130. The bearing assembly 130 allows for contact with the non-rotating sheath 60. However, the present subject matter includes variant arrangements.

The adapter die 140 defines a proximal end 142 and an opposite distal end 144. The adapter die 140 defines a recess 145 and an interior receiving region 143 accessible from the distal end 144. In the event that the ferrule 120 includes a first inclined surface 125, then the adapter die 140 defines a tapered interior region 147 of the receiving region 143. The tapered interior region 147 exhibits a mating configuration corresponding to the first inclined surface 125 of the ferrule 120 such that upon assembly of the cable coupling 102 to the cable 10, at least a majority portion of the first inclined surface 125 of the ferrule 120 contacts the tapered interior region 147. The adapter die 140 also includes an enlarged head 148 extending radially outward. The adapter die 140 also defines an aperture 141 for engagement with a rotary drive system, wherein the aperture 141 is a cross hole. The aperture 141 is similar or the same as the previously described aperture 41.

The threaded nut cap 150 defines a proximal end 152 and an opposite distal end 154. The threaded nut 150 defines an interior aperture 153 extending between the ends 152, 154. The nut cap 150 includes a threaded region 158 accessible along an interior surface of the interior aperture 153. The nut cap 150 further includes a capture region 159 sized and shaped to engage and contact the enlarged head 148 of the adapter die 140 upon assembly of the cable coupling 102. The capture region 159 is typically located adjacent the proximal end 152, however, the present subject matter includes other locations for the capture region 159. The threaded nut cap 150 typically also includes a wrench flats region 151 accessible along an exterior region of the nut cap 150. The wrench flats region 151 can be adjacent the proximal end 152 of the nut cap 150.

In many versions, the distal end 144 of the adapter die 140 includes one or more, and preferably a plurality of, axial extensions 144a. These axial extensions 144a are engaged in axial receiving region(s) 132a accessible at the proximal end 132 of the compression die 130. The compression die 130 includes one or more, and preferably a plurality of, axial receiving regions 132a. Upon insertion and engagement of the axial extension(s) 144a in the axial receiving region(s) 132a, loosening of the threaded nut 150 is precluded, in either direction.

The assembly of the cable coupling 102 to the cable 10 is the same or similar as the previously described assembly of coupling 2 to the cable 10.

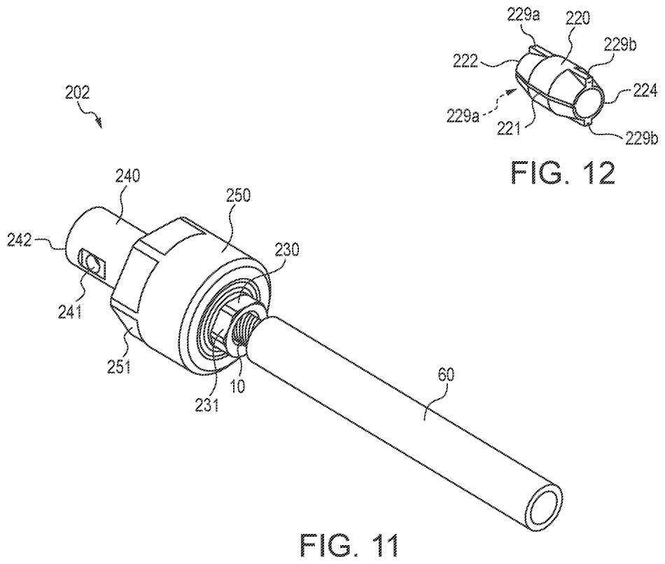

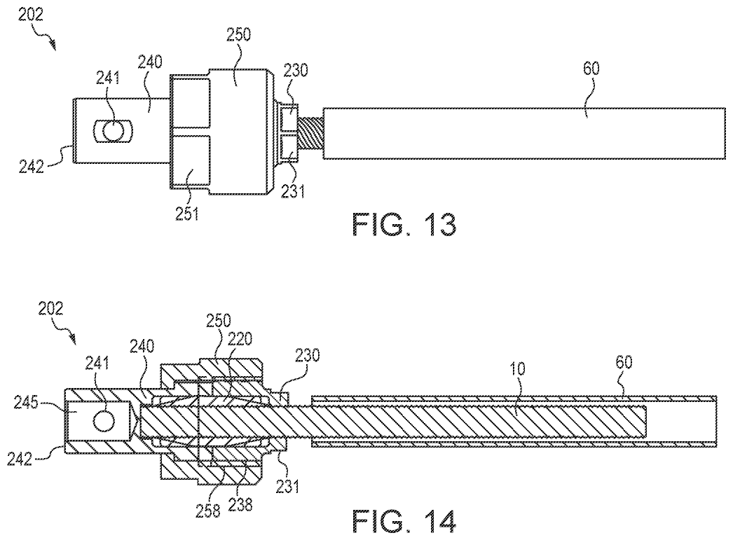

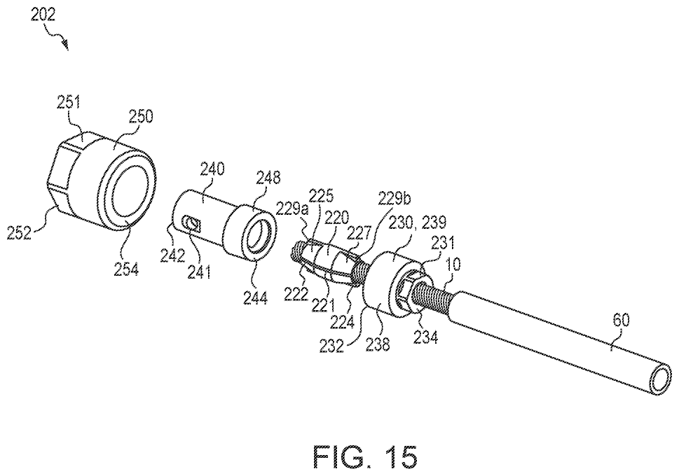

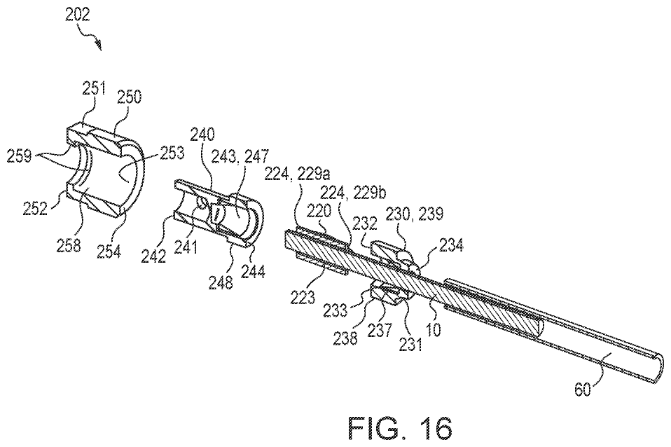

FIGS. 11-16 illustrate another embodiment of a cable coupling 202 according to the present subject matter. The cable coupling 202 comprises a ferrule 220, a threadable compression die 230, an adapter die 240, and a threaded nut cap 250. The cable coupling 202 rotatably engages a cable 10 to a drive member such as a motor. FIG. 5A illustrates such an arrangement. Typically, the cable 10 is housed within an outer cable sheath 60.

The ferrule 220 defines a proximal end 222 and an opposite distal end 224. The ferrule 220 defines an interior aperture 223 extending between the ends 222, 224. In certain versions, the ferrule 220 includes a slit 221 that extends between the ends 222, 224. The slit 221 provides access to the interior aperture 223 defined in the ferrule 220. The ferrule 220 also defines at least one inclined surface along an outer region of the ferrule 220. In the illustrated embodiment, the ferrule 220 defines a first inclined surface 225 adjacent the proximal end 222 and a second inclined surface 227 adjacent the distal end 224. However, it will be understood that the present subject matter includes the use of only one inclined surface of the ferrule 220, for example either the first inclined surface 225 or the second inclined surface 227. FIG. 12 illustrates a particular version of the ferrule 220. In this embodiment, the ferrule 220 includes at least one outwardly extending finger. In the representative ferrule 220 depicted in FIG. 12, the ferrule 220 includes a first pair of fingers 229a at the proximal end 222, and a second pair of fingers 229b at the distal end 224. It will be understood that the ferrule 220 can exhibit a wide array of shapes and configurations and is not limited to the illustrations and descriptions herein.

The compression die 230 defines a proximal end 232 and an opposite distal end 234. The compression die 230 defines an interior aperture 233 extending between the ends 232, 234. In the event that the ferrule 220 includes a second inclined surface 227, then the compression die 230 defines a tapered interior region 237 of the interior aperture 233. The tapered interior region 237 exhibits a mating configuration corresponding to the second inclined surface 227 of the ferrule 220 such that upon assembly of the cable coupling 202 to the cable 10, at least a majority portion of the second inclined surface 227 of the ferrule 220 contacts the tapered interior region 237. In the event that the ferrule 220 includes outwardly extending fingers such as fingers 229b, then the interior aperture 233 defines a receiving configuration that receives and accommodates the ferrule finger(s). The compression die 230 includes a threaded region 238 accessible along an outer surface 239 of the compression die 230. The compression die 230 typically also includes a wrench flats region 231 accessible along an exterior region of the compression die 230. The wrench flats region 231 can be adjacent the distal end 234 of the compression die 230.

The adapter die 240 defines a proximal end 242 and an opposite distal end 244. The adapter die 240 defines a recess 245 and an interior receiving region 243 accessible from the distal end 244. In the event that the ferrule 220 includes a first inclined surface 225, then the adapter die 240 defines a tapered interior region 247 of the receiving region 243. The tapered interior region 247 exhibits a mating configuration corresponding to the first inclined surface 225 of the ferrule 220 such that upon assembly of the cable coupling 202 to the cable 10, at least a majority portion of the first inclined surface 225 of the ferrule 220 contacts the tapered interior region 247. In the event that the ferrule includes outwardly extending fingers such as fingers 229a, then the interior region 247 defines a receiving configuration that receives and accommodates the ferrule finger(s). The adapter die 240 also includes an enlarged head 248 extending radially outward. The adapter die 240 also defines an aperture 241 for engagement with a rotary drive system, whereby the aperture 241 could be a cross hole. The aperture 241 is similar or the same as the previously described aperture 41.

In certain versions, the fingers 229a and 229b align and engage with mating features in the interior regions 237 of the compression die 230 and the interior region 247 of the adapter die 240, and prevent loosening of the nut 250 when the system is rotated.

The threaded nut cap 250 defines a proximal end 252 and an opposite distal end 254. The threaded nut 250 defines an interior aperture 253 extending between the ends 252, 254. The nut cap 250 includes a threaded region 258 accessible along an interior surface of the interior aperture 253. The nut cap 250 further includes a capture region 259 sized and shaped to engage and contact the enlarged head 248 of the adapter die 240 upon assembly of the cable coupling 202. The capture region 259 is typically located adjacent the proximal end 252, however, the present subject matter includes other locations for the capture region 259. The threaded nut cap 250 typically also includes a wrench flats region 251 accessible along an exterior region of the nut cap 250. The wrench flats region 251 can be located adjacent the proximal end 252 of the nut cap 250.

Until now, these cable adapters have been described as being utilized for high speed sheathed flexible drain cleaning cables. These adapters could also be utilized for non-sheathed flexible drain cleaning cables as long as the size of the adapters accommodates the size of the drain cleaning cable.

Generally, the cable couplings of the present subject matter utilize a ferrule that upon compression, enables transfer of torque from an input side of the cable coupling, i.e., the proximal end of the adapter die, to an output of the coupling engaged to a cable end to be axially rotated. The cable couplings enable transfer of torque in either direction, i.e., clockwise or counterclockwise, without loosening of the coupling. Additionally, the rotatably locking features prevent over tightening of the coupling.

The present subject matter could also be utilized to translate rotatable movement and axial movement in applications in which a coupling or adapter is needed.

In addition to the various cable couplings described herein, the present subject matter also provides assemblies of the cable couplings engaged to cables and particularly sheathed cables.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A cable coupling comprising:
a ferrule having a proximal end and a distal end, and defining an interior aperture extending between the proximal end and the distal end of the ferrule, the ferrule further having at least one inclined surface along an outer region of the ferrule;
a compression die having a proximal end and a distal end, and defining an interior aperture extending between the proximal end and the distal end of the compression die, the compression die further having a threaded region accessible along an outer surface of the compression die;
an adapter die having a proximal end and a distal end, and defining an interior receiving region accessible from the distal end of the adapter die, the adapter die further having an enlarged head;
a threaded nut cap defining a proximal end and a distal end, and defining an interior aperture extending between the proximal end and the distal end of the nut cap, the nut cap further having a threaded region accessible along the interior aperture of the nut cap, the nut cap further having a capture region sized and shaped to engage and contact the enlarged head of the adapter die upon assembly of the cable coupling.

2. The cable coupling of claim 1, wherein the ferrule includes a first inclined surface adjacent the proximal end of the ferrule, and the adapter die defines a tapered interior region of the receiving region of the adapter die, the tapered interior region exhibiting a mating configuration corresponding to the first inclined surface of the ferrule.

3. The cable coupling of claim 1, wherein the ferrule includes a second inclined surface adjacent the distal end of the ferrule, and the compression die defines a tapered interior region of the interior aperture of the compression die, the tapered interior region exhibiting a mating configuration corresponding to the second inclined surface of the ferrule.

4. The cable coupling of claim 1, wherein the ferrule further defines a slit extending between the proximal end and the distal end of the ferrule.

5. The cable coupling of claim 1, wherein the compression die includes a bearing assembly.

6. The cable coupling of claim 1, wherein the compression die and the threaded nut cap each includes a wrench flats region.

7. The cable coupling of claim 1, wherein the ferrule exhibits a cross sectional shape selected from the group consisting of circular, square, triangular, oval, and polygonal.

8. The cable coupling of claim 1, wherein the ferrule includes at least one outwardly extending finger.

9. The cable coupling of claim 8, wherein the ferrule includes a pair of fingers at the proximal end and the distal end of the ferrule.

10. The cable coupling of claim 8 wherein the at least one finger engages mating features in the interior region of the compression die and the interior region of the adapter die, which upon engagement preclude loosening of the threaded nut cap.

11. The cable coupling of claim 1 wherein the adapter die includes at least one axial extension, and the compression die includes at least one axial receiving region, wherein the at least one axial extension and the at least one axial receiving region are directly coupled together.

12. An assembly comprising:
a cable defining a proximal end;
a ferrule having a proximal end and a distal end, and defining an interior aperture extending between the proximal end and the distal end of the ferrule, the ferrule further having at least one inclined surface along an outer region of the ferrule, the cable disposed in the interior aperture of the ferrule;
a compression die having a proximal end and a distal end, and defining an interior aperture extending between the proximal end and the distal end of the compression die, the cable disposed in the interior aperture of the compression die, the compression die further having a threaded region accessible along an outer surface of the compression die;
an adapter die having a proximal end and a distal end, and defining an interior receiving region accessible from the distal end of the adapter die, the proximal end of the cable disposed in the interior receiving region of the adapter die, the adapter die further having an enlarged head;
a threaded nut cap defining a proximal end and a distal end, and defining an interior aperture extending between the proximal end and the distal end of the nut cap, the nut cap further having a threaded region accessible along the interior aperture of the nut cap, the nut cap further having a capture region sized and shaped to engage and contact the enlarged head of the adapter die upon assembly of the cable coupling.

13. The assembly of claim 12 wherein the threaded region of the nut cap is threadedly engaged with the threaded region of the compression die.

14. The assembly of claim 12 wherein the cable is rotatably disposed in a cable sheath.

15. The assembly of claim 12, wherein the ferrule includes a first inclined surface adjacent the proximal end of the ferrule, and the adapter die defines a tapered interior region of the receiving region of the adapter die, the tapered interior region exhibiting a mating configuration corresponding to the first inclined surface of the ferrule.

16. The assembly of claim 12, wherein the ferrule includes a second inclined surface adjacent the distal end of the ferrule, and the compression die defines a tapered interior region of the interior aperture of the compression die, the tapered interior region exhibiting a mating configuration corresponding to the second inclined surface of the ferrule.

17. The assembly of claim 12, wherein the ferrule further defines a slit extending between the proximal end and the distal end of the ferrule.

18. The assembly of claim 12, wherein the compression die includes a bearing assembly.

19. The assembly of claim 12, wherein each of the compression die and the threaded nut cap includes a wrench flats region.

20. The assembly of claim 12, wherein the ferrule exhibits a cross sectional shape selected from the group consisting of circular, square, triangular, oval, and polygonal.

21. The assembly of claim 12, wherein the ferrule includes at least one outwardly extending finger.

22. The assembly of claim 21, wherein the ferrule includes a pair of fingers at the proximal end and the distal end of the ferrule.

23. The assembly of claim 21 wherein the at least one finger engages mating features in the interior region of the compression die and the interior region of the adapter die.

24. The assembly of claim 12 wherein the adapter die includes at least one axial extension, and the compression die includes at least one axial receiving region, which upon engagement preclude loosening of the threaded nut cap.
